(19) United States
(12) Patent Application Publication
(10) Pub. No.: US 2003/0119528 A1
(43) Pub. Date: Jun. 26, 2003

(54) System and method for an automated intermediary to broker remote transaction between parties based on actively managed private profile information

(75) Inventors: Derek Pew, Philadelphia, PA (US); Charles L. Manto, Annapolis, MD (US); Paul Kratz, Tampa, FL (US)

Correspondence Address: GREENBERG-TRAURIG, 1750 TYSONS BOULEVARD, 12TH FLOOR, MCLEAN, VA, 22102, US

(73) Assignee: Boathouse Communication Partners, LLC, Philadelphia, PA

(21) Appl. No.: 10/244,594

(22) Filed: Sep. 17, 2002

Related U.S. Application Data
(60) Provisional application No. 60/342,109, filed on Dec. 26, 2001.

(51) Int. Cl. H04M 1/66; H04M 1/68; H04M 3/16; H04M 3/42; H04Q 7/20

(52) U.S. Cl. 455/456; 455/414; 455/411

(57) ABSTRACT

Disclosed is a system and method which provides hardware and software that in combination create an automated intermediary between parties to a transaction. The invention provides a fully automated solution that permits the creation of new markets where service level agreements (SLAs) or laws, rules and/or regulations (LRRs) require knowledge of the location of a party at some point or points in time in order to permit or facilitate the transaction. The system and method of the invention provides not only an automated auditing mechanism to demonstrate compliance with SLAs and LRRs, but by acting as an intermediary between customers and suppliers, also allows location information to remain confidential while still using it to satisfy SLAs and LRRs. The system permits and facilitates transactions between and among parties that have a defined commercial or other transactional relationship, at least one of which may be remote and using a wireless communications device. The system and method of the can use ALI technology to provide it with necessary non-static information about a remote end-user. The disclosed system and method are particularly useful where SLAs between the parties and/or between the parties and a service provider using the Invention and/or LRRs imposed by third parties must be satisfied to permit or facilitate any aspect of the interaction between the parties.

This application claims the benefit of U.S. Provisional Patent Application No. 60/342,109 entitled “System and Method for Distribution of Remote User Location Information” filed Dec. 26, 2001, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

The emergence of the Internet, cellular phones and mobile wireless devices has driven the growth of remote commerce. Remote commerce is the consummation of a commercial transaction in which the parties are not face-to-face. Remote commerce has historically been problematic for consumers and suppliers where either specific service level agreements (SLAs) or laws, rules and regulations (LRRs) imposed by governmental or other regulatory entities require specific knowledge about a consumer or supplier at any point during a transaction to make the transaction lawful or contractually practicable. Remote commerce has also been problematic for consumers or suppliers who wish to ensure that private information, critical to the consummation of a commercial transaction, is not released publicly or in a reusable manner by the other party in the remote transaction.

Many consumers are reluctant to provide generally static information such as home address, telephone and credit card information or non-static or actively monitored information such as current or future location to a supplier they do not know even if the release of such information would provide the consumer with significant conveniences and efficiencies.

In the alternative, suppliers to remote consumers do not have an automated aggregation point from which to deliver services or from which to receive critical information about the consumer without entering into individual service contracts.

In 1996, the Federal Communications Commission (FCC) began issuing orders intended to improve the quality and reliability of 911 emergency services for wireless communications users. These rules, called E-911 rules, generally require cellular carriers to be able to identify the general location from which a call is being received using Automatic Location Identification (ALI) technology. There has been limited deployment of ALI technologies in the United States to date, but widespread deployment is imminent.

Previously, only cellular carriers using Global Positioning Satellite (GPS) based technology could provide such information, and satellite-based cellular systems have not been significantly deployed in the United States except in the form of bulky GPS transponders deployed in automobiles to provide mapping and similar services.

Originally, the FCC rules on E-911 required deployment beginning on Oct. 1, 2001. However, most cellular carriers have been relieved of their obligations to comply with that date.

In response to the potential availability of location information within a cellular carrier system, several entities began exploring ways to capture the location information that is intended for use in emergency situations for commercial applications.

These entities typically view their customer as the cellular carriers and currently provide or intend to provide a commercial gateway for dissemination of location information to commercial enterprises wishing to deliver products or services based on the location of end-users.

The availability of the location information itself does not, however, solve the privacy issues that reduce potential market size or the problems inherent where either SLAs or LRRs need to be satisfied or where the remote end-user does not want location information distributed to a commercial enterprise but still desires the convenience of services that might be provided by such an enterprise.

While E-911 regulations promulgated by the Federal Communications Commission require eventual deployment of ALI technology in cellular carrier systems, such location information is not usable to satisfy SLAs and LRRs. Moreover, without combination into an automated and trusted intermediary that manages other sensitive information about a consumer or supplier, the value of the location information is attenuated because it is only part of the information that may be necessary to consummate a remote transaction.

### SUMMARY OF THE INVENTION

The above and other objects are solved by a trusted intermediary system that brokers a remote commercial transaction between a supplier and a consumer. This system provides an automated solution that permits the creation of new markets where private information is required to consummate a remote transaction or where private information must be analyzed in the context of SLAs or LRRS to determine the ability to consummate a remote transaction. Such private information may include, but is not limited to, static information such as the name, address, preferred method of payment and custom preferences of a party, and non-static information such as the current or future location of a party. The application of this invention is particularly useful where SLAs or LRRs require access to private information in order to permit a remote transaction or portion of a remote transaction to occur. The system and method of the invention not only provides an automated auditing mechanism to demonstrate compliance with SLAs and LRRs, but by acting as an intermediary between consumers and producers, also allows information to remain confidential while still using it to satisfy SLAs and LRRs.

An automated intermediary that ensures privacy solves a number of the non-static issues, but convenience and efficiency may also be substantially enhanced through the use of non-static information which has historically been impractical to remotely monitor.

The system and method of the invention in its preferred embodiment uses ALI technology to provide it with necessary non-static information about the remote end-user. The disclosed system and method are particularly useful where SLAs between the parties and/or between the parties and the service provider using the Invention and/or LRRs imposed by third parties must be satisfied to permit or facilitate any aspect of the interaction between the parties.

The system and method of the invention in its preferred embodiment further uses voice authentication technology to positively identify a party to a brokered transaction. The disclosed system and method are particularly useful when age or “opt in” authorizations are critical to brokering the transaction. The use of voice authentication technology is also particularly useful in the avoidance of fraud.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a block diagram illustrating the architectural relationships between various components of the system in a preferred embodiment of the invention.

FIG. 2 is a flow diagram illustrating a preferred method for brokering a transaction in accordance with the invention.

### DETAILED DESCRIPTION OF THE PREFERRED EMBODIMENTS

The invention in its preferred embodiment provides hardware, software, managed profile information, managed relationship rules and an auditable transaction log that in combination create an automated intermediary between a remote end-user and any other entity. The invention permits and facilitates transactions between and among parties that have a defined commercial or other transactional relationship, at least one of which is remote. Reference will now be made in detail to the preferred embodiment of the present invention.

The invention enables brokered transactions to conform to specific rules governing the relationship between a consumer and a producer and/or the disposition of a producer or a consumer. The nature of these relationship rules would include, but are not limited to, the following:

Applicable Tax Rules.

In the case where the transaction involved the payment of money, the system can use information on the known location of the parties, and the goods or services brokered in the transaction to determine the applicable taxes.

Applicable Laws.

In the case where a specific transaction requires explicit opt in authorization from a party or that a particular party be in or not be in a particular location, the system will enforce the applicable requirements. In general the system can apply jurisdictionally specific rules to any transaction.

Service Level Agreements.

In the case where the location of the end-user is the subject of product deployment or the advantage to the remote commerce.

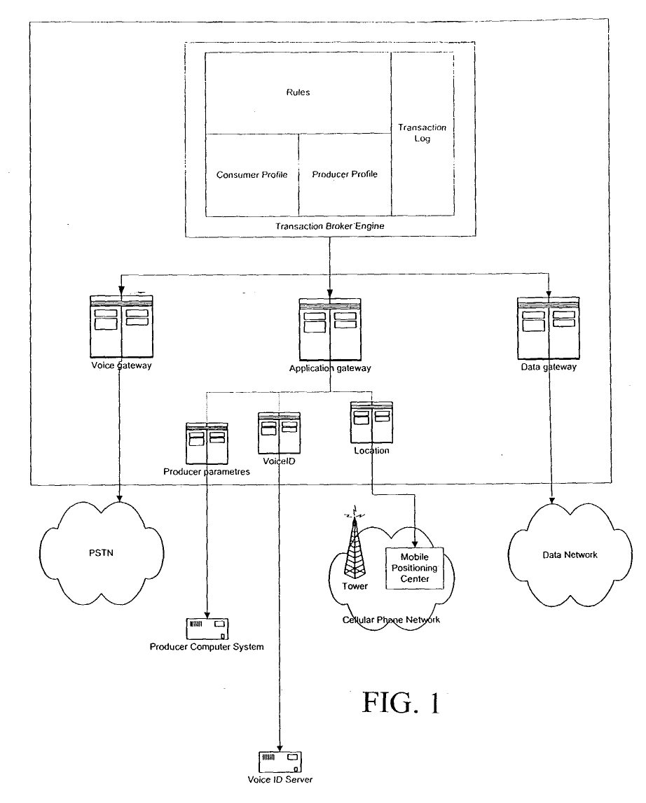

With reference to FIG. 1, the system and method of the invention uses a managed profile for a consumer and/or a producer to facilitate the brokering of a transaction. Two useful elements in a profile might be the latitude and longitude of the current location of the party. Each specific element in the profile has metadata associated with it. Such metadata would include, but not be limited to the following:

Value—The value of the element in a particular profile (e.g., if the profile element is the latitude of the current location, it might have the value of 23 degrees North).

Last Updated—The time this element's value was last updated.

Source—The source of the last update to this value. The value of this metadata field might be Web, indicating the user entered it on the web, or ALI, indicating the use of Automatic Location Identification technology to derive this information. Any suitable known location identification means may be used, including, e.g., those disclosed in U.S. Pat. No. 6,202,023 to Hancock issued Mar. 13, 2001 and U.S. Pat. No. 6,321,092 to Fitch issued Nov. 20, 2001, the entire disclosures of which are incorporated herein by reference.

The method by which the information in the profile is managed can be critical to the enabling or blocking of a transaction. The various forms this management can take include the following:

Active and verifiable, meaning the system initiates the update of information in the profile, and gets it from an independent source (e.g., the system queries the current location of a calling party from the mobile positioning center in a cellular wireless network).

Passive and verifiable, meaning the system receives an update of information in the profile from an independent source (e.g., the system receives a stock price from a reliable source).

Active and unverifiable, meaning the system initiates the update of information in the profile, and gets it from a party to any potential transaction (e.g., the system queries the make of a participating consumer's vehicle).

Passive and unverifiable, meaning an end user initiates an update to the information in their profile (e.g., an end user changes their home address or telephone number in the system).

The system and method of the invention in its preferred embodiment uses a managed set of relationship rules to ensure the integrity of a brokered transaction. These rules would be written to consider the values and reliability of specific profile information. For example—parties current location <profile value> must <reliability> be within the state of Nevada.

The processes by which static information about the customer and supplier as well as information about SLAs and LRRs for each possible action by either a customer or supplier are combined with non-static information about the location of a wireless end-user to permit or facilitate a transaction to occur is novel and does not currently exist.

The processes by which private information about the customer and supplier are used to broker a transaction while maintaining the privacy of that information is novel and does not currently exist.

The processes by which information regarding SLA and LRR compliance in the context of location information is managed, audited, stored, delivered or withheld in the context of a transactions with at least one remote, wireless end-user is novel and does nor currently exist.

The system and method of the invention preferably uses a managed profile and a set of relationship rules to broker a transaction. The transaction broker engine also has the ability to provide an audit log of a brokered transaction. The information required in the audit trail of any transaction are defined in the relationship rules themselves. In general any of the information available in the relationship rules or the managed profiles of any party to the transaction can be recorded in the transaction log at any point in the brokering of a transaction.

The system and method of the patent uses gateways to enables the transaction broker engine to communicate with external systems to facilitate the brokering of a transaction. These gateways could include, but are not limited to, those illustrated in FIG. 1, which are:

The Voice Gateway enables the transaction broker engine to communicate with a party through the public switched telephone network. The nature of this communication includes, but is not limited to, the following:

The transaction broker engine initiates a call to a consumer or a producer when it determines this is the required course of action in the potential or actual brokering of a transaction.

A consumer or a producer initiates a call to the transaction broker engine to update their profile, query the state of a transaction or simply browse the current state of the service.

The Data Gateway enables the transaction broker engine to communicate with a party by sending or receiving information through a data network. This data communication would include, but not be limited to, emails and short message service (SMS).

The Application Gateway enables the transaction broker engine to communicate with external computer systems which may be operated by a profile owner, or a third party. FIG. 1 shows three specific examples of application gateways, this is not intended to limit the scope of gateway applications.

The illustrated location application gateway has the ability to communicate with the mobile positioning center in a cellular network in order to determine the current location of a specific cellular telephone.

The illustrated voice ID application gateway has the ability to communicate with an external voice ID server that can match the voice pattern of a caller with the voice pattern on record in a profile, thus enabling the transaction broker engine to positively identify a party to a transaction.

The illustrated producer parameter application gateway has the ability to communicate with an external server operated by the owner of a producer profile that enables the unattended update of the producer profile in the transaction broker engine.

The processes by which location information is held and used in an automated intermediary between two end-users, one of whom is remote and wireless, is novel and does not currently exist.

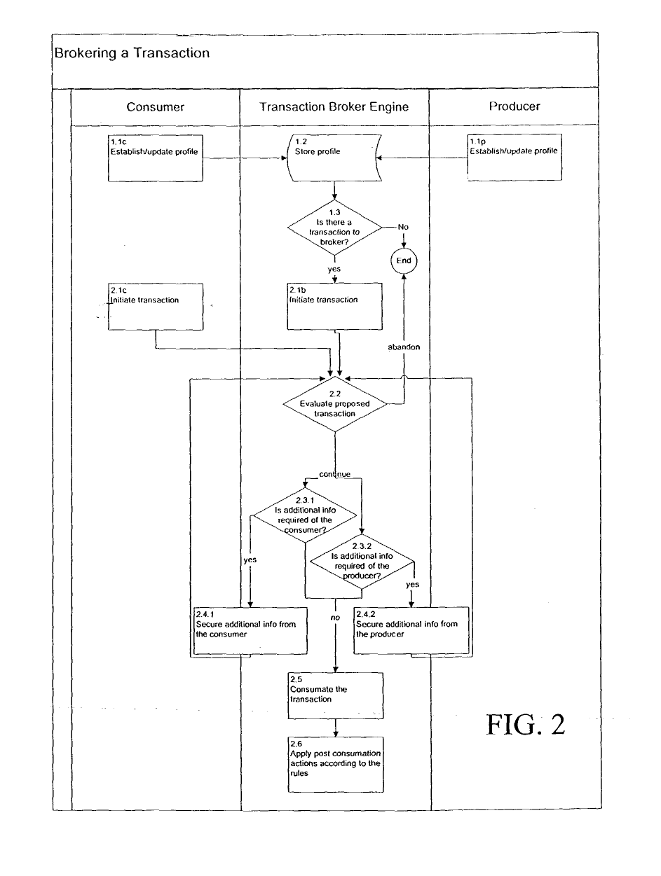

With reference to FIG. 2, the process flow in accordance with a preferred embodiment of the invention has two distinct phases, which can proceed independently of, and simultaneously with, each other. The active management of a profile is one phase. In this narrative, all process flow steps related to the management of a profile outside of the context of a transaction are designated with a step number beginning with a 1. The brokering of a transaction is the second phase, associated process flow steps are designated with a step number beginning with a 2.

The following steps describe the preferred process flow illustrated in FIG. 2:

Step 1.1c: A Customer accepts the program for remote transactions based on Relationship Rules and establishes a consumer profile. Established consumer profiles will also be updated from time to time. Successful completion of this step will lead to step 1.2. The manner in which a consumer might update their profile would include, but not be limited to, the following:

The consumer places a call through the voice gateway and enters into a prompt and response dialog resulting in the capture of new or updated information to the profile.

The consumer logs into a web site and submits a profile update via the data gateway.

The transaction broker engine initiates an attempt to locate a specific handset on the cellular phone network in accordance with specified profile preferences.

Step 1.1p: A Customer accepts the program for remote transactions based on Relationship Rules and establishes a producer profile. Established producer profiles will also be updated from time to time. Successful completion of this step will lead to step 1.2. The manner in which a producer might update their profile would include, but not be limited to, the following:

The producer places a call through the voice gateway and enters into a prompt and response dialog resulting in the capture of new or updated information to the profile.

The producer logs into a web site and submits a profile update via the data gateway.

The transaction broker engine initiates an attempt to update the profile through a producer parameter application gateway in accordance with specified profile preferences.

Step 1.2. The new or updated profile information is written to the profile, along with the meta data indicating when it was collected and where it was collected from. Go to step 1.3.

Step 1.3: Determine if there is a transaction to broker. This is accomplished by comparing the new or updated profile with the existing profiles to identify any potential matches. For example if the update to a consumer profile indicates the current position is now in the proximity of a coffee shop, and the consumer has elected to be notified of this, a potential transaction is in the offering. If the transaction broker can find any matches, it will proceed to step 2.1b, otherwise it simply stops and waits for additional updates.

Step 2.1b: The transaction broker initiates a transaction for each of the matches it could make in step 1.3 above. It is important to note that initiating the transaction does not mean that it will eventually consummate the transaction, it is merely the first in what could be many steps toward consummation.

Step 2.1c a consumer can direct the transaction broker to initiate a transaction. This might occur if a consumer browsing the services on offer decides to explore the possibility of entering into a specific transaction. For example if someone is traveling in the state of Nevada, and they do not have any lottery watches in their profile, but by browsing through the available information discover that the jackpot just hit $50,000,000 and they are only another 20 minutes left to play, that consumer might initiate the purchase of a lottery ticket.

Step 2.2 evaluate the proposed transaction in light of all applicable rules. The transaction broker considers the applicable data in the profile, SLAs, LRRs and determines any additional action that must be taken. If the transaction broker is unable to arrive at a strategy to resolve any conflicts, the transaction is abandoned. For example, the purchase of the lottery ticket mentioned above might require the transaction broker to determine conclusively that the purchaser is in the state of Nevada. If the consumer's current location is not independently known, then the transaction broker identifies the consumers current location as information that needs to be determined. Further more if the consumer is calling from a cellular phone then the transaction broker knows it can query the relevant mobile positioning center to resolve this conflict.

Step 2.3.1: If the conflict resolution strategy requires additional information from the consumer proceed to step 2.4.1

Step 2.3.2: If the conflict resolution strategy requires additional information from the producer proceed to step 2.4.2

Step 2.4.1: Secure additional information from the consumer. The transaction broker works with the consumer to resolve any obstacles to consummating the transaction. For example if the transaction broker determines that it must verify the identity of the consumer, it might submit a voice sample of the caller to the voice ID server for positive identification (see FIG. 1). Note that this step is part of a loop. The action taken to resolve one conflict (step 2.4.1 or 2.4.2) might reveal another conflict (step 2.2)

Step 2.4.2 Secure additional information from the producer. The transaction broker works with the producer to resolve any obstacles to consummating the transaction. For example if the transaction broker determines that it must verify the actual number of theatre tickets available for sale, it might submit a query to the appropriate producer parameter application gateway (see FIG. 1). Note that this step is part of a loop. The action taken to resolve one conflict (step 2.4.2 or 2.4.1) might reveal another conflict (step 2.2)

Step 2.5: If all the transaction conflicts have been resolved, then the transaction can be consumated. In other words all parties are committed and accountable for the transaction.

Step 2.6: Apply any post consummation actions according to the rules. This might include logging of any transaction details.

It is worth noting explicitly that there is nothing in this method of brokering a transaction that limits the number of parties to a transaction. In particular it is anticipated that this same method of brokering a transaction would apply where there are multiple consumers and/or multiple suppliers in a transaction.

### EXAMPLE 1

### State Lotteries and Lawful, Regulated Gaming

The LRRs of these industries require specific information about the geographic location and identity of the Customer as well as the manner of consummation for any transaction and the disposition of actions.

The SLAs in this context must also satisfy the LRRs. Customers may permit outright, permit in a limited context or not permit unsolicited notifications or actions, and Relationship Rules are developed for each Customer pairing.

The Lottery or Gaming Enterprise Customer may provide a series of opt-in or mandatory notifications as part of its standard SLA. These notifications may include notifications that do not require geographic knowledge of the remote Customer and notifications that do.

In this manner, a Customer with the appropriate SLA might receive a message about a gaming opportunity such as “the lottery has now reached $25 million,” or “the jackpot has reached $25 million,” or “the event you were interested in wagering on will begin at a certain time.” That same customer might also receive a promotional message such as “did you know that you could give directly to the charitable organizations serving the same needs as the lottery,” or “you have earned a complimentary dinner and show at the Gaming Entity Customer.” These messages may not be regulated by the LRRs and, therefore may be made without regard to the location of the remote Customer.

The same notifications can also be tailored to the geographic location and identity of the remote Customer where such Customer might receive a message like “you have just entered into the lottery zone, the jackpot is $25 million would you like to buy any tickets,” or “would you like to place a wager, the jackpot is $25 million.”

In the alternative, the remote Customer might choose to initiate an action: “what lottery is available to me,” or “what gaming opportunity is available to me?”

These action/notifications on the part of either Customer in a relationship pairing would be the initial action in a potential series of actions that could lead to a consummated commercial transaction.

The decision matrix in accordance with the Relationship Rules would analyze each responsive action. “Yes I would like to buy a ticket,” or “yes I would like to place a bet,” or “remote customer's line is busy,” or “no thank you,” each lead to a different path in the decision matrix. Where necessary, the decision matrix would initiate the creation of an audit trail so that compliance with LRRs is documented for purposes of regulatory bodies and Customers.

In the event that a commercial transaction is ready to be consummated, the Relationship Rules determine whether the transaction can be consummated in the manner proposed by the Customers in accordance with the Relationship Rules. “You have just purchased five tickets for the Pick Five Lottery, press the pound symbol to confirm” or “you have just bet $5 on the jackpot game of chance, press the pound symbol to confirm.”

### EXAMPLE 2

### “Find Me” and Other Automated Commercial Services

The SLAs of these industries require identification of the location of remote end-users. In addition, LRRs, such as sales and service taxes, may need to be collected in connection with the location of the end-user at various stages of a transaction.

Customers may permit outright, permit in a limited context or not permit unsolicited notifications or actions and Relationship Rules are developed for each Customer pairing.

The Remote Commerce Provider Customer may provide a series of opt-in or mandatory notifications as part of its standard SLA. These notifications may include notifications that do not require geographic knowledge of the remote Customer and notifications that do.

In this manner, a Customer with the appropriate SLA might receive a message about an available service or product such as “you have been traveling for five hours, a gas station with your specified grade of fuel is within two miles with prices below your specified level, would you like directions,” or an advertisement like “your preferred hotel is within five miles and has reservations available, would you like to make one.” These messages may or may not be regulated by LRRs, and the Invention would interface the Relationship Rules with non-static location information to satisfy the SLAs.

In the alternative, the remote Customer might elect to initiate an action like “need diapers.” Such an action would initiate a series of actions subsequent actions that would ultimately identify the fastest commercial alternative available for the Customer to receive the desired item in a fully automated way.

The “need diapers” command could be sent to the “find-me” service that has SLAs with a number of providers based on the category of product or service required. The response of the “find-me” Customer may be an automated order in compliance with SLAs that broadcasts a request for service to its suppliers. The location of the Remote Customer may be known or unknown to the “find-me” Customer depending on its SLA with its Remote Customer. In this way, the Invention protects the privacy of the Remote Customer by automatically using the location of such Customer without disclosing it unless previously authorized to do so, while still providing the Remote Customer with the convenience created by allowing location to be determined automatically.

The response of the targeted suppliers, “yes we have diapers,” or “no we do not have diapers,” is merely another initiating action in the context of the various Relationship Rules.

In this way, customer pairings interact with each other in a potentially limitless pattern to allow otherwise difficult or impossible to solve SLAs and LRRs to be satisfied in concert.

These action/notifications on the part of either Customer in a relationship pairing would be the initial action in a potential series of actions that could lead to a consummated commercial transaction.

The decision matrix in accordance with the Relationship Rules would analyze each responsive action. “Yes I need gas,” or “yes I need a room,” or “remote customer's line is busy,” or “no thank you,” each lead to a different path in the decision matrix. Where necessary, the decision matrix would initiate the creation of an audit trail so that compliance with LRRs is documented for purposes of regulatory bodies and Customers.

In the event that a commercial transaction is ready to be consummated, the Relationship Rules determine whether the transaction can be consummated in the manner proposed by the Customers in accordance with the Relationship Rules. “Thank you for your reservation” or “here are your directions.”

### EXAMPLE 3

### Directed Public Service Activities

For certain public service purposes, the identification of the location of an end-user as well as the movement of that end-user during a transactional period may be important.

In the context of “tax-free” zones, special promotions that are launched by municipalities or larger regions, or for traffic or other information, specific SLAs can be created between remote Customers and governmental or public Service Customers.

As in any commercial transaction, the Public Service Customer may provide a series of opt-in or mandatory notifications as part of its standard SLA. These notifications may include notifications that do not require geographic knowledge of the remote Customer and notifications that do.

In this manner, a Customer with the appropriate SLA might receive a message about special promotions or other incentives created by the public service organization. “Did you know that all hotel rooms in this section of the city are only $100 tonight,” or “you have entered a “tax-free” zone—buy from a merchant here and you will pay no sales tax.” These messages may or may not be regulated by LRRs, and the Invention would interface the Relationship Rules with non-static location information to satisfy the SLAs.

In the alternative, the remote Customer might elect to initiate an action like “any special incentives where I am” or “give me directions to the nearest public service or governmental location,” or “am I allowed to park here,” or “where and how do I vote.”

These action/notifications on the part of either Customer in a relationship pairing would be the initial action in a potential series of actions that may need to be monitored for purposes of satisfying SLAs and providing information to public service entities.

The decision matrix in accordance with the Relationship Rules would analyze each responsive action. “Yes, how do I take advantage of the promotion,” or “parking is permitted on the south side of 18^{th} Street on Saturdays,” or “remote customer's line is busy,” or “no thank you,” each lead to a different path in the decision matrix. Where necessary, the decision matrix would initiate the creation of an audit trail so that compliance with LRRs is documented for purposes of regulatory bodies and Customers.

Auditable information about the location of the end-user and the types of actions initiated by Customers would be audited and delivered in accordance with SLAs.

### EXAMPLE 4

### House Arrest

With most municipalities facing significant prison overcrowding issues, the use of location information through something worn by or attached to a convict permits detailed monitoring and permits “house arrest” as an alternative to traditional incarceration.

Currently GPS technology that is used with a transmitter placed in a handcuff attached to the house arrest convict is the preferred technology, however, the invention would permit a cellular solution by providing an automated clearinghouse for information on multiple convicts in accordance with each such convicts house arrest directives.

### OTHER EXAMPLES

In addition to the gaming, “find me,” Directed Public Service and “house arrest” embodiments described above, the concepts of the invention may be applied in numerous other embodiments without departing from the spirit and scope of the invention. Such applications include, e.g., trading in securities markets or pursuant to securities law exemptions, enforcing laws such as prohibitions on cellular phone use in automobiles, assessing sales and other taxes for various transactions, providing location authentication for automated commerce transactions that use the cellular communications device as the front-end of the consummation of a purchase such as a soda at a vending machine, monitoring employees as a management tool where the location of employees must be monitored, providing automated information among soldiers or police officers in military and law enforcement uses, combining multiple service offerings for the convenience of a wireless end-user, as a means of tracking shipments and enhancing “just in time” services, providing further enhanced emergency services by automatically coordinating multiple participants in search and rescue or other emergency response situations, and providing family safety solutions among others.

While the invention has been particularly shown and described with reference to the preferred embodiments thereof, it will be understood by those skilled in the art that various changes in form and details may be made therein without departing from the spirit and scope of the invention.

The embodiments of the invention in which an exclusive property or privilege is claimed are defined as follows:

1. An automated intermediary system for brokering remote transactions between parties, comprising:
means for storing a plurality of user profiles, each user profile comprising data identifying a location of a user at a given time;
means for receiving updates to said user profiles, said updates comprising updates to said data identifying a location of a user at a given time;
means for storing relationship rules governing the propriety of transactions between users, said relationship rules comprising rules dependent upon a location of a user;
means for applying said relationship rules to said data identifying a location of a user at a given time to determine the propriety of a transaction between a first user and a second user;
means for communicating to said first user data authorizing said transaction between said first user and said second user without disclosure of data identifying a location of said second user.

2. The automated intermediary system for brokering remote transactions between parties in accordance with claim 1, wherein said first user is a provider and said second user is a consumer.

3. The automated intermediary system for brokering remote transactions between parties in accordance with claim 1, wherein said means for receiving updates to said user profiles comprises means for receiving automatic location identification data.

4. The automated intermediary system for brokering remote transactions between parties in accordance with claim 1, wherein said means for receiving updates to said user profiles comprises a voice gateway for receiving a call from said second user and for executing prompt and response dialogs resulting in the capture of new or updated information to said user profiles.

5. The automated intermediary system for brokering remote transactions between parties in accordance with claim 1, wherein said means for receiving updates to said user profiles comprises a data gateway for receiving profile updates from users via an internet connection.

6. The automated intermediary system for brokering remote transactions between parties in accordance with claim 1, wherein said means for receiving updates to said user profiles comprises a transaction broker engine for initiating an attempt to locate a specific handset on the cellular phone network in accordance with specified profile preferences.

7. The automated intermediary system for brokering remote transactions between parties in accordance with claim 1, wherein said means for storing relationship rules governing the propriety of transactions between users comprises means for storing rules for determining whether said transactions comply with laws, rules or regulations imposed by governmental or regulatory entities.

8. The automated intermediary system for brokering remote transactions between parties in accordance with claim 1, wherein said means for storing relationship rules governing the propriety of transactions between users comprises means for storing rules for determining whether said transactions comply with service level agreements.

9. The automated intermediary system for brokering remote transactions between parties in accordance with claim 1, means for creating and storing an audit trail to document compliance with laws, rules or regulations imposed by governmental or regulatory entities.

10. The automated intermediary system for brokering remote transactions between parties in accordance with claim 1, wherein said means for storing a plurality of user profiles comprises means for storing producer profiles and consumer profiles.

11. The automated intermediary system for brokering remote transactions between parties in accordance with claim 1, wherein said means for communicating is configured to ensure that a profile of said first user is not disclosed to said second user and that a profile of said second user is not disclosed to said first user.

12. The automated intermediary system for brokering remote transactions between parties in accordance with claim 1, wherein said means for receiving updates to said user profiles comprises means for receiving location data from a wireless device operated by said second user.

13. The automated intermediary system for brokering remote transactions between parties in accordance with claim 1, wherein said means for receiving updates to said user profiles comprises means for performing voice identification to match a voice pattern of a caller with a voice pattern on record in a profile and thereby positively identify a party to a transaction.
